(19) United States
(12) Patent Application Publication
(10) Pub. No.: US 2009/0262059 A1
(43) Pub. Date: Oct. 22, 2009

(54) TIMING CONTROLLER, LIQUID CRYSTAL DISPLAY, AND METHOD FOR DRIVING THE SAME

(76) Inventors: Te-Chen Chung, Kun Shan (CN); Chia-Te Liao, Kun Shan (CN)

Correspondence Address: Nixon Peabody LLP, 200 Page Mill Road, Suite 200, Palo Alto, CA, 94306, US

(21) Appl. No.: 12/189,789

(22) Filed: Aug. 12, 2008

(30) Foreign Application Priority Data
Apr. 21, 2008 (CN) 200810095011.7

(51) Int. Cl. G09G 3/36

(52) U.S. Cl. 345/96; 345/94

(57) ABSTRACT

A timing controller, an LCD, and a method for driving the LCD are provided. The LCD comprises an LCD panel having a plurality of gate lines and source lines, a data driver, and a scanning driver. The scanning driver supplies a m-pulse scanning signal to each of the gate lines of the LCD panel, wherein m is an integer equal to or larger than 2. The second pulse of the m-pulse scanning signal supplied to the n-th gate line is in synchronization with the first pulse of the m-pulse scanning signal supplied to the (n+1)-th gate line, wherein n is an integer equal to or larger than 1.

### TECHNICAL FIELD

The present invention relates to a liquid crystal display. In particular, the present invention relates to a time controller, a liquid crystal display, and a method for driving the same that may improve the display quality of the liquid crystal display.

### BACKGROUND

A display transforms an electric signal processed by an information processing device to an image. Such a display includes a liquid crystal display (LCD) device, an organic light-emitting diode (OLED) device, and a plasma display panel (PDP), etc.

The LCD includes a plurality of gate lines extending along a first direction of a substrate, a plurality of source lines extending along a second direction of the substrate perpendicular to the first direction, a plurality of thin film transistors (TFTs), and a plurality of liquid crystal capacitors and storage capacitors.

The gate lines are triggered sequentially. When one of the gate lines is triggered, a data voltage is applied to a pixel electrode of a liquid crystal capacitor through a source line, thereby charging the liquid crystal capacitor.

The time period between the triggering of the first gate line and the triggering of the last gate line is defined as a frame.

Recently, as the resolution of a TFT-LCD increases with the increased popularity of high definition, the number of gate lines is also increasing. However, the time of a frame is fixed regardless of the number of gate lines. As a result, the time used for triggering each gate line must decrease.

As described above, when a gate line is triggered, a data voltage is applied to the pixel electrode of the corresponding liquid crystal capacitor. Therefore, as the time used for triggering each gate line decreases, the time used for charging the liquid crystal capacitor decreases as well. As a result, the voltage on the pixel electrode of the liquid crystal capacitor may be lower than the data voltage. In other words, the charging rate of the liquid crystal capacitor may decrease, thereby failing to obtain the charge required by a grey scale display.

Moreover, the LCD has a drawback of low response speed. When driving frequency is increased for reducing the after image effect due to the low response speed, the time used for charging the liquid crystal capacitor further decreases.

In order to achieve good display quality, the charging capacity of the TFTs in a LCD must be improved, i.e., the on current of the TFT, Ion, has to be increased as much as possible. In general, the width to length ratio (W/L) of the TFT may be increased to reduce a threshold voltage VT, thereby increasing the on current Ion, as described in detail with reference to FIG. 1 below.

FIG. 1 illustrates a single pixel unit of a conventional LCD panel. Here, to simplify description, only an array substrate provided with gate lines, source lines and TFTs is shown in FIG. 1. A color filter substrate disposed opposite to the array substrate and having a common electrode is not shown. As shown in FIG. 1, a pixel electrode 1 is disposed in the region formed between a gate line 3 and a source line 2, and a TFT 4 is disposed at the crossing of the gate line 3 and the source line 2. A common electrode line 9 is disposed in parallel to the gate line. The TFT 4 comprises a source electrode 5, a drain electrode 6, an active layer 7 and a gate electrode (part of the gate line 3, not shown). The drain electrode 6 of the TFT is electrically connected to the pixel electrode 1 through a through hole 8, and the gate electrode is electrically connected to the gate line. Moreover, the common electrode line 9 and the pixel electrode 1 form a storage capacitor (Cst) of the pixel unit, and the pixel electrode and a common electrode on the color filter substrate (not shown) form a liquid crystal capacitor (Clc) of the pixel unit.

A scanning signal applied on a gate line 3 may control turning the TFT 4 on and off. When a scanning signal is applied on a certain gate line 3, all of the TFTs electrically connected with the gate line are turned on simultaneously, so that display information is transferred between the source lines 2 and the pixel electrodes 1 (i.e., data voltages are transferred from the drain electrodes 6 of the TFTs electrically connected with the gate line to the respective pixel electrodes via the through holes 8), the pixel electrode 1 is charged, and the value of voltages on the pixel electrodes 1 stays the same after charging. At this point, however, the TFTs electrically connected with other gate lines are in an off state, and the respective pixel electrodes are not connected with the source lines. When the scanning signal applied on the gate line 3 is withdrawn, all of the TFTs electrically connected with the gate line are in an off state, and the value of voltages on the respective pixel electrodes will be maintained by the storage capacitors and the liquid crystal capacitors, until the arrival of a next scanning signal (i.e., TFT is in an on state again).

When the TFT 4 is in an on state, electrons in the active layer 7 will migrate between the source electrode 5 and the drain electrode 6, thereby transferring a signal to the pixel electrode 1 through the source line 2. As the width to length ratio (W/L) of the channel of the TFT 4 increases, the on current of the TFT also increases, thereby enhancing the charging abilities of the TFT. However, while the width to length ratio W/L increases, a parasitic capacitance Cgs formed between the drain electrode 6 and the gate electrode (part of the gate line 3, not shown) of the TFT also increases. Since the increase of Cgs will influence the display effect of the LCD, such increase is not desirable. Moreover, although the charging abilities of the TFT is proportional to the width to length ratio W/L, when the TFT is disposed in the same region as the pixel electrode 1, the area of the pixel electrode 1 through which light passes decreases as W increases, thereby reducing the visual area to human eyes. The values of the width and length of TFT will not achieve the exact expected effect due to the limitation of the precision of photolithography process in the course of manufacture. Therefore, when TFT device is designed, various factors described above, process capacity and costs need to be taken into consideration in order to choose appropriate device parameters and materials.

To enhance the charging abilities of the TFT, a driving circuit of the LCD can be used to perform a two-pulse scanning with pre-charging on the LCD, i.e., inputting two scanning signals into each gate line during one frame, which will be described in more details below with reference to FIG. 2.

Referring to FIG. 2, a simulation diagram of a conventional two-pulse scanning is shown. The parameters of the LCD are as follows: the length of the TFT is 6 μm, the width of the TFT is 22 μm, the capacitance of the storage capacitor Cst is 303.4f, capacitance of the liquid crystal capacitor Clc is 223.8f, the parasitic capacitance formed between the drain electrode and the gate electrode Cgs is 40 f, the high voltage on the gate line Vgh is 19V, and the low voltage on the gate line Vgl is −6V. As shown in FIG. 2, a reference number 10 indicates a waveform of a data voltage being input, and a reference number 30 indicates a waveform of a voltage on the pixel electrode. When a first scanning signal 20a turns on a TFT electrically connected with a certain gate line, a data voltage on the gate line begins to perform a pre-charging operation on the corresponding pixel electrode, which is the preparation for the charging operation on the pixel electrode by the data voltage when a second scanning signal 20b turns on the TFT electrically connected with the gate line. As can be seen, when the TFT is turned on, a data voltage is applied to the corresponding pixel electrode through a source line; when the TFT is turned off, the pixel electrode maintains a pixel voltage as shown in FIG. 2. In this manner, when scanning is completed, the charging ability of the TFT reaches 94.13% of maximum.

The time interval between the first scanning signal 20a and the second scanning signal 20b of a two-pulse scanning is a period of time during which a single pulse is inputted. In this period, a low voltage scanning signal is inputted into the gate line, and the TFT is turned off. When the first scanning signal 20a turns on the TFTs electrically connected with the (n+1)th gate line and a pre-charging operation on the pixel electrode corresponding to the (n+1)th gate line is performed through the source line, the n-th gate line is being inputted a low voltage. At this time, the TFTs electrically connected with the n-th gate line are turned off. That is, the amount of pre-charging for the pixel electrode corresponding to the (n+1)th gate line depends on the data voltage provided additionally, and is independent of the amount of charging for the pixel electrode corresponding to the n-th gate line. In this case, the load of a data driver is increased, while there is no substantial improvement in charging ability.

### SUMMARY

Embodiments of the present invention provide a timing controller for controlling the timing of a multi-pulse scanning signal, a LCD and a method for driving the LCD, which greatly improve the charging ability for a TFT.

According an embodiment of the invention, a timing controller is provided. The timing controller is used with a scanning driver, the scanning driver being used for driving a LCD panel having a plurality of gate lines and source lines and sequentially supplying a m-pulse scanning signal to each of the gate lines of the LCD panel, wherein m is an integer equal to or larger than two. When the scanning driver sequentially supplies a m-pulse scanning signal to each of the gate lines of the LCD panel, the timing controller is configured to control the timing of the m-pulse scanning signal supplied to each of the gate lines of the LCD panel, so that a rising edge of a second pulse of the m-pulse scanning signal supplied to the n-th gate line corresponds to a rising edge of a first pulse of the m-pulse scanning signal supplied to the (n+1)th gate line, wherein n is an integer equal to or larger than one.

According another embodiment of the invention, a LCD is provided. The LCD comprises a LCD panel having a plurality of gate lines and source lines; a data driver; and a scanning driver, the scanning driver sequentially supplying a m-pulse scanning signal to each of the gate lines of the LCD panel, wherein m is an integer equal to or larger than two, and wherein a rising edge of a second pulse of the m-pulse scanning signal supplied to the n-th gate line corresponds to a rising edge of a first pulse of the m-pulse scanning signal supplied to the (n+1)th gate line, wherein n is an integer equal to or larger than one.

According another embodiment of the invention, a method for driving a LCD having a LCD panel is provided, the LCD panel having a plurality of gate lines and source lines. The method comprises: sequentially supplying a m-pulse scanning signal to each of the gate lines of the LCD panel, wherein m is an integer equal to or larger than two, and wherein a rising edge of a second pulse of the m-pulse scanning signal supplied to the n-th gate line corresponds to a rising edge of a first pulse of the m-pulse scanning signal supplied to the (n+1)th gate line, wherein n is an integer equal to or larger than one.

The invention can be better understood based on the detailed description of the embodiments below, with reference to the drawings.

### BRIEF DESCRIPTION OF THE DRAWINGS

FIG. 1 shows a single pixel unit of a conventional LCD panel;

FIG. 2 shows a simulation diagram for a conventional two-pulse scanning;

FIGS. 3a and 3b show equivalent circuits for a part of a LCD panel in accordance with a first embodiment of the present invention;

FIG. 4 shows a waveform of a multi-pulse scanning being applied to each of the gate lines of the LCD panel according to the first embodiment of the present invention;

FIG. 5 shows a simulation diagram of the best case of the multi-pulse scanning according to the first embodiment of the present invention;

FIG. 6 shows a simulation diagram of the worst case of the multi-pulse scanning according to the first embodiment of the present invention;

FIG. 7 shows an equivalent circuit for a part of a LCD panel in accordance with a second embodiment of the present invention;

FIG. 8 shows a block diagram of a LCD according to embodiments of the present invention; and

FIG. 9 shows an example of the relationship between the timing controller and the gate driver of FIG. 8.

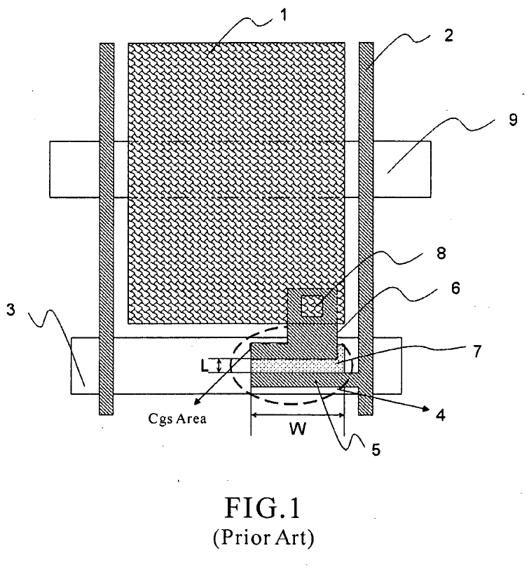

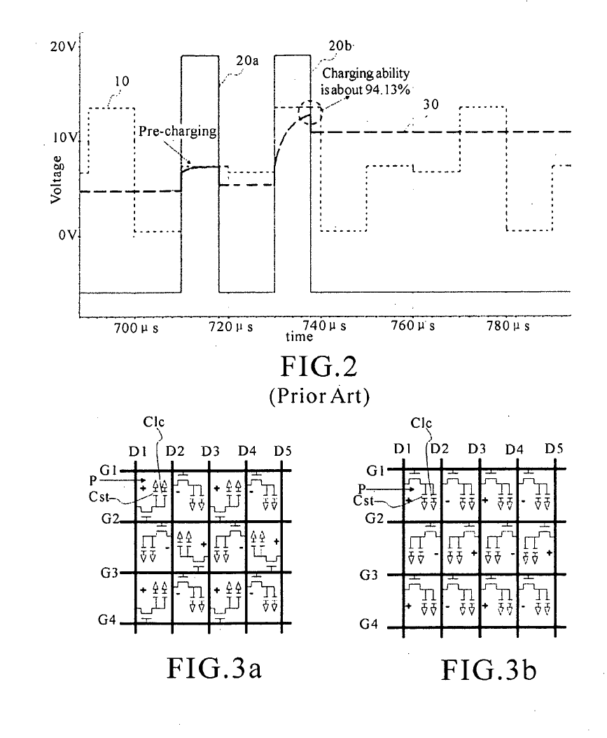

### DETAILED DESCRIPTION OF THE INVENTION

Hereinafter, the exemplary embodiments of the present invention are illustrated with reference to the drawings. For the purposes of the invention, a layout of a new TFT-LCD is provided herein.

First, a first embodiment of the invention is illustrated with reference to FIG. 3 to FIG. 6.

FIGS. 3a and 3b show equivalent circuits for a part of a LCD panel in accordance with a first embodiment of the present invention. As shown in FIGS. 3a and 3b, the LCD panel of the present invention comprises m×n pixel units (P), wherein m indicates a number of columns of the pixel unit (only 4 columns are shown), and n indicates a number of rows of the pixel units (only 3 rows are shown). The basic structure of each pixel unit is similar to that of a pixel unit described in the background, therefore the description thereof is omitted. In FIGS. 3a and 3b, a sign (+) represents a positive polarity pixel unit, and a sign (−) represents a negative polarity pixel unit. For example, during the period of the n-th frame, a data voltage higher than a common voltage Vcom (a voltage on a common electrode of a color filter substrate) is applied to a pixel electrode, and a pixel unit comprising the pixel electrode has a positive polarity. During the period of the (N+1)th frame, a data voltage lower than the common voltage Vcom is applied to a pixel electrode, and a pixel unit comprising the pixel electrode has a negative polarity. The two kinds of LCD panels of FIGS. 3a and 3b are both applied a driving method using column inversion (at each frame, data voltages of the same polarity are inputted into respective data lines), wherein respective pixel units show a dot inversion effect and are pre-charged. In the case of a dot inversion, a pixel unit and a neighboring pixel thereof are opposite in polarity, and any two pixel units of the same polarity are not adjacent.

Referring to FIG. 3a, an equivalent circuit for a part of a LCD panel in accordance with the first embodiment of the present invention is shown. This LCD panel may use a column inversion driving method for presenting a dot inversion driving effect on pixel units. As shown in FIG. 3a, D1, D2, D3, D4 and D5 indicate source lines of the LCD panel, and G1, G2, G3 and G4 indicate gate lines of the LCD panel. Each source line electrically connects all the pixel units P of the same polarity in two adjacent columns (for example, the s-th column and the (s+1)th column) of pixel units P, and each gate line electrically connects all the positive polarity pixel units in the r-th row of pixel units P and all the negative polarity pixel unit in the (r+1)th row of pixel units P. For example, a source line D2 electrically connects a negative polarity pixel unit in column 1, row 2 and two negative polarity pixels in column 2, row 1 and column 2, row 3. A gate line G2 electrically connects two positive polarity pixel units in column 1, row 1 and column 3, row 1 and two negative polarity pixels in column 1, row 2 and column 3, row 2. In the following, the source lines and the gate lines of the LCD panel are described in the same manner.

Referring to FIG. 3b, another equivalent circuit for a part of a LCD panel in accordance with the first embodiment of the present invention is shown. The LCD panel may use a column inversion driving method for presenting a dot inversion driving effect on pixel units. As shown in FIG. 3b, D1, D2, D3, D4 and D5 indicate source lines of the LCD panel. Each source line electrically connects all the pixel units P of the same polarity in two adjacent columns (for example, the s-th column and the (s+1)th column) of pixel units P, and each gate line electrically connects all the pixel units P in a certain row (the r-th row) of pixel units P. For example, a source line D2 electrically connects a negative polarity pixel unit in column 1, row 2 and two negative polarity pixels in column 2, row 1 and column 2, row 3. A gate line G2 electrically connects all the positive pixel units P in the second row of pixel units P.

As can be seen from comparison, the two kinds of LCD panels shown in FIGS. 3b and 3a are different in that each gate line in the LCD panel shown in FIG. 3b electrically connects all the pixel units P in a certain row of pixel units P and controls all the pixel units P in the row of pixel units P via corresponding TFTs.

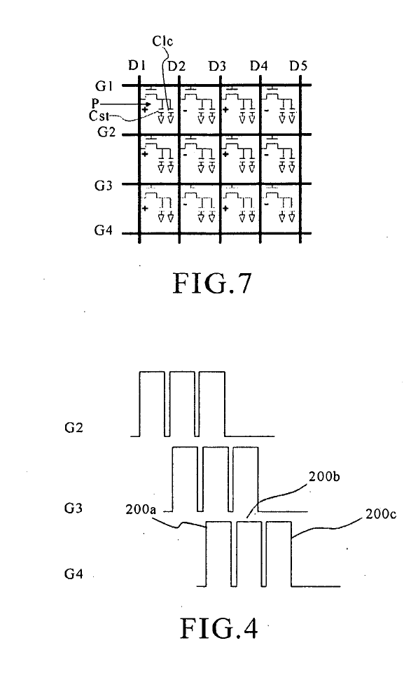

FIG. 4 shows a waveform of multiple pulses (i.e., multi-pulse scanning) applied to each gate line of a LCD panel according to the first embodiment of the present invention.

An example of charging pixel units by a multi-pulse scanning according to the first embodiment of the present invention will now be described with reference to FIGS. 3a and 4. As shown in FIG. 4, a scanning signal having three pulses is used in this example, wherein the widths of the three pulses are the same and the intervals between any adjacent two of the three pulses are the same. In FIG. 3a, a pixel unit G1D2 represents a pixel unit in which the gate electrode of the TFT is electrically connected to the gate line G1 and the source electrode of the TFT is connected to the source line D2. In the following, respective pixel units are described in the same manner. In FIG. 4, the waveforms of the multi-pulse scanning as indicated by G2, G3 and G4 represent scanning signals applied to gate lines G2, G3 and G4 respectively.

Assuming that a positive polarity voltage is charged into a pixel unit G4D3 electrically connected with the gate line G4 when the third pulse scanning signal 200c is being applied to the gate line G4, and the positive polarity voltages of the same gray scale are sequentially charged into a pixel unit G2D3 and a pixel unit G3D3 before a positive polarity voltage is charged into the pixel unit G4D3. In accordance with an embodiment of the present invention, as to the pixel unit G4D3, the time period during which the first pulse scanning signal 200a and the second pulse scanning signal 200b are applied to the gate line G4 corresponds to the time period during which the pixel unit G4D3 is pre-charged. The time period during which the first pulse scanning signal 200a is input to the gate line G4 corresponds to the time period during which the pixel unit G2D3 is charged, and the time period during which the second pulse scanning signal 200b is input to the gate line G4 corresponds to the time period during which the pixel unit G3D3 is charged (at which time data voltages are applied to the respective pixel units through the TFTs). Specifically, as shown in FIG. 4, the time period during which the first pulse scanning signal 200a is applied to the gate line G4 corresponds to the time period during which the last pulse scanning signal is applied to the gate line G2, and the time period during which the second pulse scanning signal 200b is applied to the gate line G4 corresponds to the time period during which the last pulse scanning signal is applied to the gate line G3. That is, while the pixel units G2D3 and G3D3 are being charged, the pixel unit G4D3 is being pre-charged. Since gray scale voltages are the same, the amount of voltage pre-charged into the pixel unit G4D3 is equal to the amount of voltage charged into the pixel units G2D3 and G3D3. Moreover, since positive polarity voltages of the same gray scale are sequentially charged into the pixel unit G2D3 and the pixel unit G3D3 before a positive polarity voltage is charged into the pixel unit G4D3, the amount of voltage pre-charged into the pixel unit G4D3 is equal to the amount of voltage being charged, which is the optimal state for pre-charging. The case with waveforms of the multi-pulse scannings of FIGS. 3b and 4 is similar to that of FIG. 3a, therefore the description thereof is omitted.

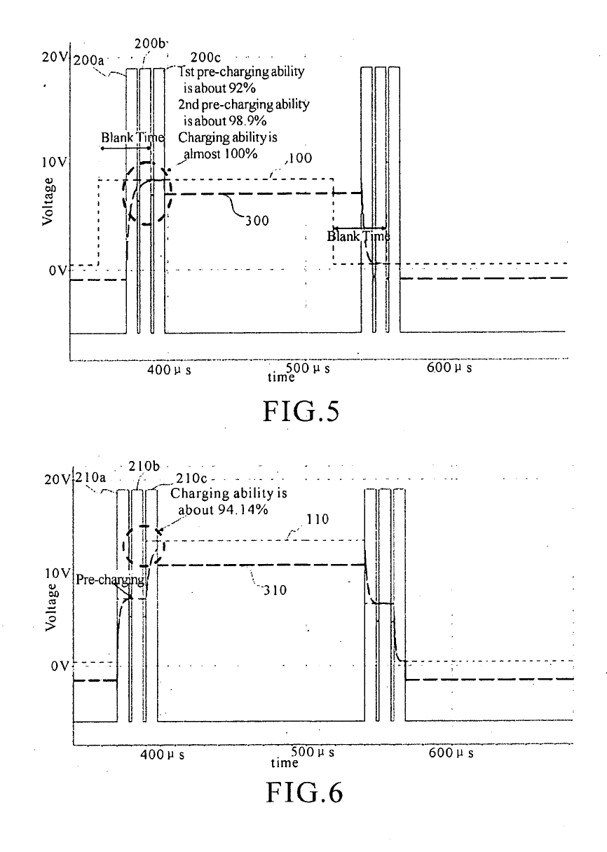

FIG. 5 shows a simulation diagram of the best case of the multi-pulse scanning according to the first embodiment of the present invention. The parameters of the LCD panel are as follows: TFT length=6 μm, TFT width=22 μm, Cst=303.4 f, Clc=223.8 f, Cgs=40 f, Vgh=19V, and Vgl=−6V. In FIG. 5, a numeral reference 100 indicates a waveform of a data voltage being input, and a numeral reference 300 indicates a waveform of a pixel voltage on the pixel electrode. In the optimal state described above, when the amount of voltage pre-charged into the pixel unit G4D3 during the time period when the first pulse scanning signal 200a and the second pulse scanning signal 200b are applied to the gate line G4 is equal to the amount of voltage charged into the pixel unit G4D3 during the time period when the third pulse scanning signal 200c is applied to the gate line G4, the charging rate for the pixel unit is approximately 100%, which greatly improves the charging ability of the pixel unit.

Even in the worst case, the charging ability of the pixel unit can still be kept at a high level. It is assumed that a positive polarity voltage is charged into the pixel unit G4D3 during the time period when the third pulse scanning signal 200c is applied to the gate line G4, and positive polarity voltages of different gray scales are sequentially charged into the pixel unit G2D3 and the pixel unit G3D3 (for example, a positive polarity voltage of black gray scale is charged into the pixel unit G4D3, and a positive polarity voltage of white gray scale is charged into the pixel unit G2D3 and the pixel unit G3D3) before the pixel unit G4D3 is charged. At this point, the amount of voltage pre-charged into the pixel unit G4D3 during the time period when the first pulse scanning signal 200a is applied to gate line G4 is equal to the amount of voltage charged into the pixel unit G2D3, and the amount of voltage pre-charged into the pixel unit G4D3 during the time period when the second pulse scanning signal 200a is applied to gate line G4 is equal to the amount of voltage charged into the pixel unit G3D3, both of which are white level voltages about one half of the amount of voltage charged into the pixel unit G4D3 during the time period when the third pulse scanning signal is applied to the gate line G4. Even though such a case is the worst case for pre-charging as compared with the best case for pre-charging described above, the charging for a pixel unit can still be done very well by using the multi-pulse scanning scheme of the present invention.

FIG. 6 shows a simulation diagram of the worst case of the multi-pulse scanning according to the first embodiment of the present invention. The parameters of the LCD panel are as follows: TFT length=6 μm, TFT width=22 μm, Cst=303.4 f, Clc=223.8 f, Cgs=40 f, Vgh=19V, and Vgl=−6V. In FIG. 6, a numeral reference 110 indicates a waveform of a data voltage being input, and a numeral reference 310 indicates a waveform of a pixel voltage on the pixel electrode. A pixel unit is pre-charged during the time period when the first pulse scanning signal 210a and the second pulse scanning signal 210b are applied to the gate line (for example, a low voltage of white gray scale is charged into the pixel unit), and the pixel unit is charged during the time period when the third pulse scanning signal 210c is applied to the gate line (for example, a high voltage of black gray scale is charged into the pixel unit). As shown in FIG. 6, the charging rate for a pixel unit can reach 94.14% even in the worst case. Compared with the traditional two-pulse scanning, the pre-charging ability for the multi-pulse scanning of an embodiment of the present invention can be as good even in the worst case for pre-charging.

The embodiment of the present invention may apply to a LCD panel as shown in FIGS. 3a and 3b which use a column inversion driving method for presenting a dot inversion driving effect on pixel units. It is also possible to apply such a scheme to the case of column inversion driving in a common LCD panel.

FIG. 7 shows an equivalent circuit for a part of a LCD panel according to the second embodiment of the present invention. When a column inversion driving is used, the amount of voltage pre-charged into a positive polarity pixel unit G3D1 is equal to the amount of voltage charged into a positive polarity pixel units G1D1 and G2D1. In accordance with said column inversion driving, a data voltage is applied to liquid crystal capacitors electrically connected to the same source line, and a data voltage of a different polarity is applied to liquid crystal capacitors electrically connected to an adjacent source line. In this case, the way that a pixel unit is charged using multi-pulse scanning is the same as that of the first embodiment, so the description thereof is omitted.

In an embodiment of the present invention, a scanning signal having three sequential pulses is used for driving the gate lines. The interval between the first and second pulses applied to the gate line is the time period during which a corresponding pixel unit is pre-charged. Moreover, since there are some blank time from the end of the n-th frame to the start of the (n+1)th frame (i.e. a time period during which no effective scanning signal is applied to the gate line), the interval between the first pulse and the second pulse applied to the gate lines for the first row of pixel units and the amount of voltage charged into the respective pixel units during the time period when a first pulse is applied to the second row of pixel units can be improved based on different designs, and are not limited to the embodiments shown.

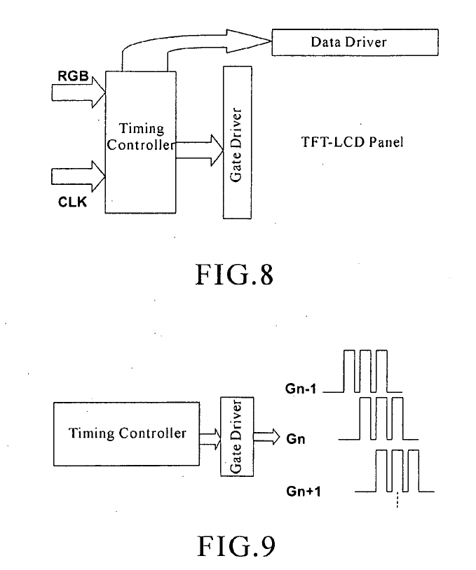

FIG. 8 shows a block diagram of a LCD according to an embodiment of the present invention.

Referring to FIG. 8, the functional units of the LCD according to an embodiment of the present invention are shown. The LCD comprises a data driver, a gate driver, a timing controller, a TFT-LCD panel and etc. The data driver is electrically connected to source lines (not shown) of the LCD panel, and is used for providing a data voltage for each source line of the LCD panel. The gate driver is electrically connected to the gate lines (not shown) of the LCD panel, and is used for providing a m-pulse scanning signal to each of the gate lines of the LCD panel (as shown in FIG. 9 below, for example), wherein m is an integer equal to or larger than 2. The timing controller provides a timing control signal for the gate driver and the data driver. The control signal is supplied to the gate driver, which controls the timings of the m-pulse scanning signal sequentially supplied to the respective gate line, so as to implement the multi-pulse scanning according to the first and second embodiments of the present invention.

The first pulse to the (m−1)th pulse of the m-pulse scanning signal supplied to the LCD panel by the gate driver is used to trigger a gate line so that the respective pixel units of the LCD panel, which are connected to the gate line, can be pre-charged, and the m-th pulse thereof is used to trigger the gate line so that the respective pixel units of the LCD panel, which are connected to the gate line, can be charged.

The TFT-LCD panel used in FIG. 8 can either be an LCD panel using column inversion driving method for presenting a dot inversion driving effect on pixel units, or an LCD panel for implementing column inversion driving, wherein the former can be the TFT-LCD panels as shown in FIGS. 3a and 3b. Moreover, the functional units of the LCD in FIG. 8 are not limited the configuration shown. Instead, they can be integrated or separated as necessary, without departing from spirit and scope of the present invention. For example, the timing controller can be integrated into the gate driver.

FIG. 9 shows an example of the relationship between the timing controller and the gate driver of FIG. 8 according to an embodiment of the present invention.

In FIG. 9, a gate driver provides a three-pulse scanning signal sequentially for each gate line (not shown) of the LCD panel, wherein the widths of the three pulses are the same and the intervals between any adjacent two of the three pulses are the same. As shown in FIG. 9, a timing controller provides a timing control signal to a gate driver, the timing control signal controls the timing of the three-pulse scanning signal sequentially supplied to the respective gate lines, so that the rising edge of the second pulse of the three-pulse scanning signal supplied to the (n−1)th gate line corresponds to the rising edge of the first pulse of the three-pulse scanning signal supplied to the n-th gate line, wherein n is an integer equal to or larger than 2.

The present invention has been described by way of embodiments thereof. However, it should be understood that modifications and adjustments to these embodiments may occur to a person of ordinary skill in the art, without departing from the scope as defined by the appended claims.

What is claimed is:

1. A timing controller used with a scanning driver, the scanning driver being used for driving a liquid crystal display panel having a plurality of gate lines and source lines and sequentially supplying a m-pulse scanning signal to each of the gate lines, wherein m is an integer equal to or larger than two, and wherein
the timing controller is configured to control the timing of the m-pulse scanning signal supplied to each of the gate lines, so that a rising edge of a second pulse of the m-pulse scanning signal supplied to the n-th gate line corresponds to a rising edge of a first pulse of the m-pulse scanning signal supplied to the (n+1)th gate line, wherein n is an integer equal to or larger than one.

2. The timing controller according to claim 1, wherein
the pulse widths of m pulses of the m-pulse scanning signal are the same, and the time intervals between any adjacent two pulses of the m pluses are the same.

3. The timing controller according to claim 1, wherein
the first pulse to the (m−1)th pulse of the m-pulse scanning signal are pulses for starting a pre-charging operation for respective pixel units of the liquid crystal display panel, and the m-th pulse of the m-pulse scanning signal is a pulse for starting a charging operation for the respective pixel units of the liquid crystal display panel.

4. The timing controller according to claim 1, wherein
the timing controller is configured to supply a timing control signal to the scanning driver, thereby controlling the timing of the m-pulse scanning signals sequentially supplied to the respective gate lines.

5. The timing controller according to claim 1, wherein
the timing controller is integrated into the scanning driver.

6. A liquid crystal display comprising:
a liquid crystal display panel having a plurality of gate lines and source lines;
a data driver; and
a scanning driver configured to sequentially supply a m-pulse scanning signal to each of the gate lines, wherein m is an integer equal to or larger than two, and wherein
a rising edge of a second pulse of the m-pulse scanning signal supplied to the n-th gate line corresponds to a rising edge of a first pulse of the m-pulse scanning signal supplied to the (n+1)th gate line, wherein
n is an integer equal to or larger than one.

7. The liquid crystal display according to claim 6, wherein
the pulse widths of m pulses of the m-pulse scanning signal are the same, and the time intervals between any adjacent two pulses of the m pluses are the same.

8. The liquid crystal display according to claim 6, wherein
the first pulse to the (m−1)th pulse of the m-pulse scanning signal are pulses for starting a pre-charging operation for respective pixel units of the liquid crystal display panel, and the m-th pulse of the m-pulse scanning signal is a pulse for starting a charging operation for the respective pixel units of the liquid crystal display panel.

9. The liquid crystal display according to claim 6, wherein
each source line of the liquid crystal display panel electrically connects pixel units of the same polarity in two adjacent columns of pixel units.

10. The liquid crystal display according to claim 9, wherein
each gate line of the liquid crystal display panel electrically connects pixel units of odd or even columns in two adjacent rows of pixel units.

11. The liquid crystal display according to claim 6, wherein
each gate line of the liquid crystal display panel electrically connects a single row of pixel units.

12. The liquid crystal display according to claim 6, wherein
each source line of the liquid crystal display panel electrically connects pixel units of the same polarity in a single column of pixel units.

13. The liquid crystal display according to claim 12, wherein
each gate line of the liquid crystal display panel electrically connects a single row of pixel units.

14. A method for driving a liquid crystal display comprising a liquid crystal display panel, the liquid crystal display panel having a plurality of gate lines and source lines, the method comprising:
sequentially supplying a m-pulse scanning signal to each of the gate lines of the liquid crystal display panel, wherein m is an integer equal to or larger than two, wherein
a rising edge of a second pulse of the m-pulse scanning signal supplied to the n-th gate line corresponds to a rising edge of a first pulse of the m-pulse scanning signal supplied to the (n+1)th gate line, wherein n is an integer equal to or larger than one.

15. The method according to claim 14, wherein the supplying the m-pulse scanning signal to each of the gate lines comprises supplying to each of the gate lines a scanning signal with m pulses having the same pulse width and the same time interval between any adjacent two pulses.

16. The method according to claim 14, further comprising:
supplying the first pulse to the (m−1)th pulse of the m-pulse scanning signal to pre-charge respective pixel units of the liquid crystal display panel, and
supplying the m-th pulse of the m-pulse scanning signal to charge the respective pixel units.

17. The method according to claim 16, wherein to pre-charge the respective pixel units of the liquid crystal display panel comprises pre-charging the pixel unit of the liquid crystal display panel using a column inversion driving.
